(19) United States
(12) Patent Application Publication
(10) Pub. No.: US 2019/0208603 A1
(43) Pub. Date: Jul. 4, 2019

(54) Orientation Aware Luminaire

(71) Applicant: Michael A. Quilici, Essex, MA (US)

(72) Inventor: Michael A. Quilici, Essex, MA (US)

(73) Assignee: OSRAM SYLVANIA Inc., Wilmington, MA (US)

(21) Appl. No.: 15/860,846

(22) Filed: Jan. 3, 2018

(51) Int. Cl. H05B 37/02; G06F 3/0482

(52) U.S. Cl. CPC H05B 37/0227; G06F 3/04847; G06F 3/0482; H05B 37/0272

(57) ABSTRACT

An orientation-aware luminaire and a method of operating an orientation-aware luminaire are disclosed herein. The luminaire includes a light source, at least one orientation sensor configured to provide orientation output representative of the position of the luminaire relative to a subject, and a controller communicatively coupled the light source. The controller provides control signals to provide a light output for illuminating the subject in response to the orientation output of the orientation sensor. The color or intensity of the light output may be determined from a lighting scene.

### TECHNICAL FIELD

The present application relates to lighting, and more particularly, to an orientation-aware luminaire.

### BACKGROUND

Designing lighting systems for different environments involves a number of non-trivial challenges, and designing lighting systems for contextual lighting environments includes particular issues.

### BRIEF DESCRIPTION OF THE DRAWINGS

FIG. 1 diagrammatically illustrates a lighting system in accordance with an embodiment of the present disclosure.

FIG. 2 diagrammatically illustrates a top view the lighting system shown in FIG. 1.

FIG. 3 is a block diagram of a lighting system in accordance with an embodiment of the present disclosure.

FIG. 4 diagrammatically illustrates a lighting system in accordance with an embodiment of the present disclosure including a plurality of luminaires.

FIG. 5 is a front view of a system controller showing a selected lighting scene in accordance with an embodiment of the present disclosure.

FIG. 6 is a front view of a system controller showing a painted lighting scene in accordance with an embodiment of the present disclosure.

These and other features of the present embodiments will be understood better by reading the following detailed description, taken together with the figures herein described. The accompanying drawings are not intended to be drawn to scale. In the drawings, each identical or nearly identical component that is illustrated in various figures may be represented by a like numeral. For purposes of clarity, not every component may be labeled in every drawing.

### DETAILED DESCRIPTION

The present disclosure is directed to a luminaire that produces a light output spectrum based on its physical location. For example, in some embodiments the position of the luminaire with respect to a desired lighting scene and a subject may determine the output spectrum of the luminaire. In some embodiments, the luminaire includes one or more orientation sensors and a processor for calculating light output color(s) of the luminaire that mimic the color(s) of a position in the lighting scene corresponding to the position of the luminaire with respect to a subject.

The lighting scenes can be acquired from one or more images, and may be stored in a memory on the luminaire or may be stored in a location remote from the luminaire, e.g. in a system controller or remote memory. In some embodiments, for example, the lighting scene can be acquired from one or more photograph images, video images and/or rendered images. A coordinate system may be assigned to the lighting scene and the luminaire may be configured to determine its output color(s) and/or intensity based on its location in the lighting scene as indicated by the orientation sensor(s).

In some embodiments, the output color(s) and/or intensity of the luminaire may adjust in real-time as it is moved with respect to a subject. This may be especially useful for lighting environments such as theatre, film and photography where lights are frequently moved to achieve desired lighting for a subject. Even in situations where luminaires are infrequently moved, the ability of the luminaires to dynamically change as they are installed may be useful with commissioning a lighting system.

In some embodiments, a luminaire in accordance with the present disclosure may be controlled through a user interface, e.g. a hard-wired or wireless (e.g. radio-based or optical) interface such as a personal computer, smart phone, tablet or other mobile device. The interface may be configured to allow the user to select the desired lighting scene, e.g. from a database of lighting scenes, create custom lighting scenes and/or modify the color and intensity of individual luminaires. In some embodiments, the interface may display a lighting scene image, e.g. mapped onto a sphere or projected flat, and allow the user to fix the heading or orientation of the lighting scene with respect to the luminaire. The interface may allow rotation of the lighting scene by swiping across the screen while the output colors and intensity of the luminaires dynamically change to match the rotation. In some embodiments, the user interface may include paint mode that allows the user to create custom lighting scenes by painting directly on the lighting scene image with different colors.

As will be appreciated in light of this disclosure, a luminaire configured as described herein may be considered, in a general sense, a robust, intelligent, lighting platform that provides flexible and easily adaptable lighting to match a desired scene. Some embodiments may realize a reduction in cost, for example, as a result of reduced installation, operation, and other labor costs. Furthermore, the scalability and orientation of a luminaire configured as described herein may be varied, in accordance with some embodiments, to adapt to a specific lighting context or application.

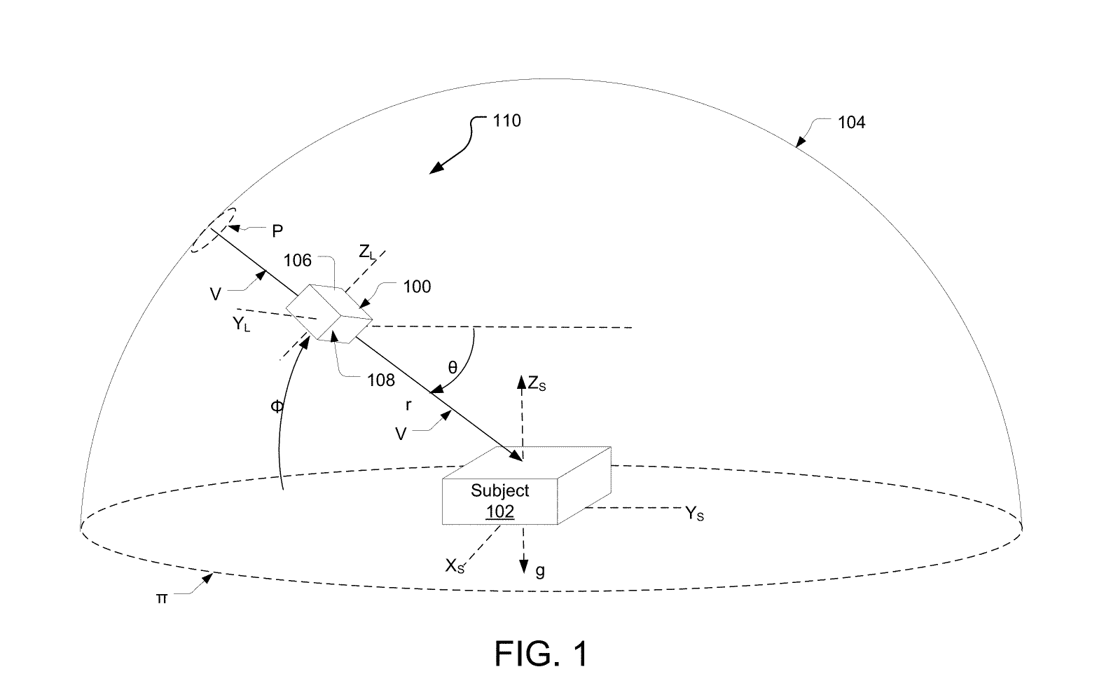

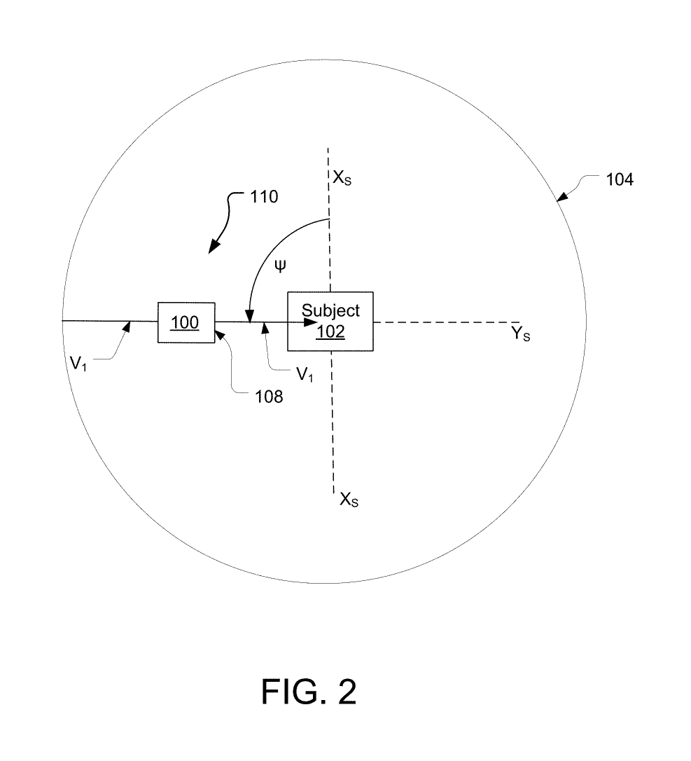

FIGS. 1 and 2 diagrammatically illustrate a lighting system 110 including a luminaire 100 positioned for illuminating a subject 102 with color(s) and intensity based on the position of the luminaire 100 with respect to the subject 102 in a lighting scene 104 in accordance with an embodiment of the present disclosure. The lighting scene 104 is depicted as a photosphere in FIGS. 1 and 2 for ease of explanation. The lighting scene 104 is not a physical structure, but instead may be a digital representation of a scene acquired from one or more images, and may be stored in a memory on the luminaire 100 or may be stored in a location remote from the luminaire 100, e.g. in a system controller or a remote memory such as a cloud-based storage device. A coordinate system may be assigned to the lighting scene 104 and the luminaire 100 may be configured to determine its output color(s) and intensity based on its location in the lighting scene 104 as indicated by one or more orientation sensor(s) associated with the luminaire 100. FIGS. 1 and 2 depict the lighting scene 104 as a hemispherical photosphere only for ease of explanation in describing the relative position of the luminaire 100 within a lighting scene 104.

The luminaire 100 includes a housing 106 that at least partially encloses one or more lights sources (not shown). Light from the light source(s) is emitted through a light output surface 108 of the luminaire 100 and is controlled to mimic the color associated with the corresponding lighting scene 104 position. In a general sense, the light imparted on the subject 102 by the luminaire 100 coincides with light that would be imparted on the subject 102 if the subject 100 were actually in natural light represented by the lighting scene 104.

In accordance with some embodiments, the light source(s) of the luminaire 100 may include one or more solid-state light source(s). A given solid-state light source may include one or more solid-state emitters, which may be any of a wide range of semiconductor light source devices, such as, for example: (1) a light-emitting diode (LED); (2) an organic light-emitting diode (OLED); (3) a polymer light-emitting diode (PLED); and/or (4) a combination of any one or more thereof. In some embodiments, a given solid-state emitter may be configured for emissions of a single correlated color temperature (CCT) (e.g., a white light-emitting semiconductor light source). In some other embodiments, however, a given solid-state emitter may be configured for color-tunable emissions. For instance, in some cases, a given solid-state emitter may be a multi-color (e.g., bi-color, tri-color, etc.) semiconductor light source configured for a combination of emissions, such as: (1) red-green-blue (RGB); (2) red-green-blue-yellow (RGBY); (3) red-green-blue-white (RGBW); (4) dual-white; and/or (5) a combination of any one or more thereof. In some embodiments, the luminaire 100 may emit polarized light through the use of polarized light sources, filters or other optical elements. This may be useful to reduce specular reflection off a subject because vertically polarized light is preferentially absorbed or refracted. If the output of the luminaire 100 vertically polarized, the glare from specular reflection can be reduced.

Multiple solid-state light source(s) in a luminaire 100 consistent with the present disclosure may be tunable individually or collectively to produce a light output including a single color or color gradients in a light distribution area. As used herein the “light distribution area” of a single luminaire 100 is the area of a subject 102 illuminated by the luminaire. As used herein “color gradient” refers to any change in color from one location in a light distribution area to another area of a light distribution area.

In accordance with some embodiments, a luminaire 100 consistent with the present disclosure may include other light source(s) in addition to, or in the alternative to, solid-state light source(s), such as incandescent or fluorescent lighting, for example. The quantity and arrangement of light source(s) utilized for each luminaire may be customized as desired for a given subject or end-use.

In accordance with some embodiments, the disclosed luminaire 100 may be mounted, for example, from a ceiling, wall, floor, step, or other suitable surface, or may be configured as a free-standing lighting device, such as a desk lamp or torchiére lamp, and may be positioned in a desired orientation relative to a subject. For example, a luminaire 100 as shown in FIG. 1 may be mounted at a desired height, distance and rotation relative to the subject 102 using an optional mounting bracket.

With reference to FIG. 1, the orientation of the luminaire may be at least partially described by an orientation vector V that extends through a surface, e.g. the light output surface 108, of the luminaire 100 and intersects the subject 102 in the light distribution area of the luminaire. In some embodiments, for example, the pitch of the luminaire 100 with respect to the horizontal plane and the yaw (rotational position) of luminaire 100 with respect to the northern cardinal direction may be described with reference to the position of the orientation vector V with respect to reference axes associated with the luminaire 100 and the subject 102. For example, the subject reference axes may include a vertical subject reference axis Z_{S} that passes vertically (e.g. opposite to the gravitational force vector g) through the subject 102, a perpendicular subject reference axis X_{S} orthogonal to the vertical subject reference axis Z_{S} and parallel to the northern cardinal direction, and a lateral subject reference axis Y_{S} orthogonal to the vertical subject reference Z_{S} axis and the perpendicular subject reference axis X_{S}. The luminaire reference axes may include a vertical luminaire Z_{L} reference axis orthogonal to the orientation vector V and a lateral luminaire Y_{L} reference axis orthogonal to the vertical luminaire reference axis Z_{L} and orthogonal to the orientation vector V.

Using the reference axes and the orientation vector V, the altitude of the luminaire 100 relative to the subject 102 and the azimuth of the luminaire 100 with respect to the subject 102 may be described in a variety of ways. In some embodiments, for example, the altitude may be considered as the angle ϕ between the horizontal plane Π and the luminaire 100, as illustrated in FIG. 1. The pitch of the luminaire 100 may be defined as the angle between the vertical luminaire axis Z_{L} and the gravitational vector g, or equivalently, as shown in FIG. 1 the angle θ between a plane extending through the luminaire 100 and parallel to the horizontal plane Π and the orientation vector V. The relationship between pitch θ and altitude ϕ may be described using the formula ϕ=−θ. Using that definition of the altitude ϕ, when the orientation vector V is parallel to the horizontal plane, the luminaire 100 may have an altitude ϕ=0 degrees and a pitch θ=0 degrees, and when the orientation vector V is parallel with the gravitational force vector, the luminaire 100 may have an altitude ϕ=90 degrees and a pitch ο=−90 degrees.

With reference to FIG. 2, which is a top diagrammatic view of the lighting system 110 shown in FIG. 1, the azimuth (rotational position) of the luminaire 100 with respect to the subject 102 may be defined by the horizontal angle between the northern cardinal direction and the luminaire 100. The yaw of the luminaire 100 may be defined as the angle Ψ between the northern cardinal direction and horizontal component of the orientation vector V₁. In FIG. 2 the northern and southern cardinal directions are coincident with the perpendicular subject reference axis X_{S}. The relationship between azimuth and yaw may be described using the formula azimuth=yaw−180 degrees. Using that definition, when the horizontal component of the orientation vector V₁ is parallel to the southern cardinal direction and V₁ is aimed toward the subject 102, the luminaire 100 may have an azimuth of 0 degrees and a yaw Ψ=180 degrees, and when the horizontal component of the orientation vector V₁ is parallel to the northern cardinal direction and aimed toward the opposite side of the subject 102, the luminaire 100 may have an azimuth of −180 degrees and a yaw Ψ=0 degrees. With this definition, the azimuth of the luminaire 100 with respect to the subject 102 is defined for 360 degrees of rotation of the luminaire 100 around the subject 102.

In some embodiments, the luminaire 100 may include one or more orientation sensors configured to provide orientation outputs representative of the altitude, azimuth and distance of the luminaire 100 from the subject 102. The orientation outputs are provided to a processor in the luminaire 100 or a processor located remotely from the luminaire 100. In some embodiments, for example, the luminaire 100 may include a known accelerometer and magnetometer and, optionally, a gyroscope, configured for providing outputs representative of the pitch and yaw of the luminaire 100 relative to the subject. Examples of known orientation sensors useful in a luminaire 100 consistent with the present disclosure are the LSM9DSO inertial module and the LSM303AGR e-compass module which are commercially available from STMicroelectronics, Geneva, Switzerland. The luminaire 100 may also include a known and commercially available optical distance sensor, e.g. a known ultrasonic or infrared time-of-flight sensor, for providing an orientation output representative of the distance of the luminaire 100 to the subject 102. The processor may calculate the position of the luminaire 100 with respect to the subject 102 from the orientation outputs.

The light output of the luminaire 100 illuminates the subject 102 and is provided in response to the orientation output(s) of the orientation sensor(s). In some embodiments, for example, the position of the luminaire 100 with respect to the subject 102 may be used to determine a corresponding position in a lighting scene 104 relative to the subject 102 and the light source(s) of the luminaire 100 may be controlled to illuminate the subject 102 with light that mimics the color and/or intensity associated with the corresponding position in the lighting scene 104. With reference again to FIG. 1, for example, the position of the luminaire 100 in the lighting scene 104 relative to the subject 102 may be described by altitude, azimuth and distance. The orientation of the luminaire 100 may be described by the orientation vector V that is in the direction of light output of the luminaire 100. As shown, the orientation vector V extends through the luminaire 100 and intersects the lighting scene 104 at a position or area, P. In the illustrated embodiment the luminaire 100 may be controlled to illuminate the subject 102 with light that mimics the color and intensity associated with the corresponding lighting scene position, P.

As previously noted, a lighting scene 104 can be acquired from one or more images, and may be stored in a memory on the luminaire 100 or may be stored in a location remote from the luminaire 100, e.g. in cloud-based storage. In some embodiments, for example, the lighting scene 104 can be acquired from one or more photograph images, video images, and/or rendered images. In some embodiments, the image from which the lighting scene 104 is produced can be acquired from one or more 360 degree photographs. Known 360 degree cameras produce red-green-blue (RGB) color information, e.g. from every angle in a hemisphere around camera. In some embodiments, an RGB image may be acquired through high-dynamic-range imagining (HDR), where multiple images are captured at different exposure values and combined. In some embodiments, hyperspectral images, providing spectral information at every pixel, may be acquired with a hyperspectral camera, filter wheel, spectrometer or other device. In some embodiments, hyper-spectral images for a lighting scene 104 can be produced by replacing RGB color in an image with full spectral information from a database of spectra of various objects such as water, trees, sky, grass, etc.

A lighting scene 104 can be produced from one or more images, and a correspondence between the lighting scene and data representative of the positional output(s) may be established. The color of the luminaire light output may be controlled based on the correspondence. For example, a lighting scene may be created by assigning a coordinate system to the images and associating a color and intensity of with each coordinate, or with groups of coordinates, in the system. In some embodiments, for example, the image(s) may be stored as flat equi-rectangular images and the color of each pixel in the image can be assigned to an associated value of the altitude and azimuth of the scene. The orientation outputs of the orientation sensor(s) of the luminaire 100 may provide outputs representative of pitch and yaw, and the controller of the luminaire 100 can use a look-up table to identify the pixel or pixels associated with the altitude and azimuth in the lighting scene 104 corresponding position of the luminaire 100. A controller may then control the light source(s) of the luminaire 100 to provide an output color matching the color of the pixel(s) assigned to the altitude and azimuth of the lighting scene 100.

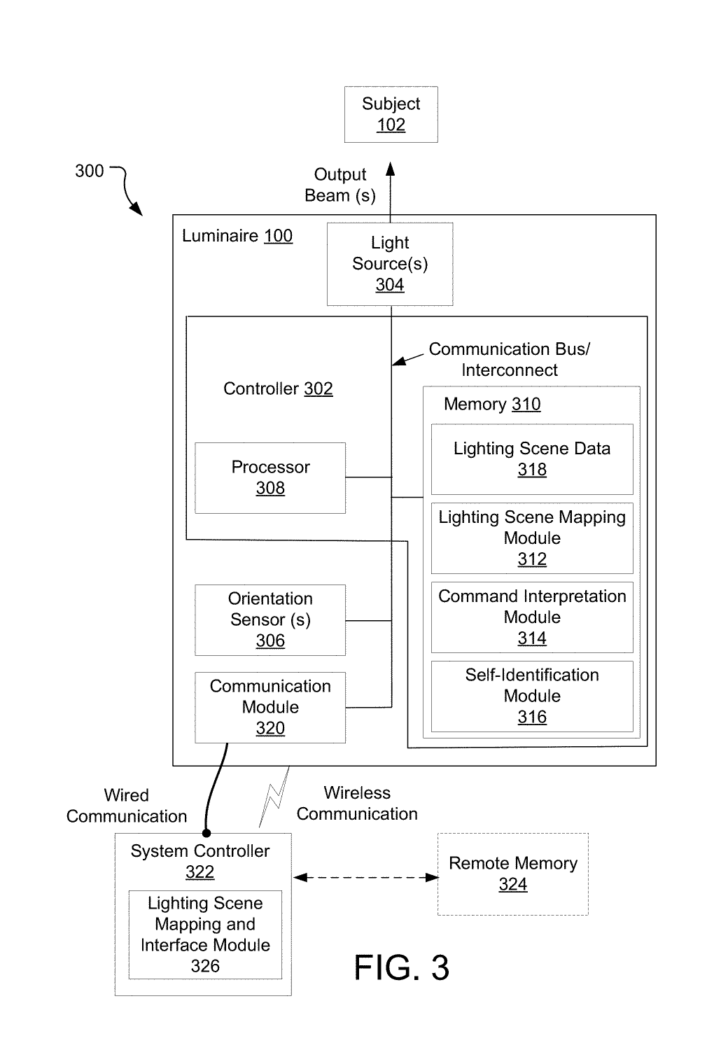

The controller may also control the intensity of light source(s) of the luminaire 100 in response to the distance of the luminaire 100 from the subject 102 indicated by a distance sensor of the luminaire 100. The distance sensor may be one of the orientation sensors 306 discussed with reference to FIG. 3. The distance sensor may provide the luminaire 100 with the ability to compensate for the distance-squared irradiance falloff so that the irradiance on the subject 102 remains constant regardless of the distance between the subject 102 and the luminaire 100. The distance between the luminaire 100 and the subject 102 may also be used to scale the overall intensity of all multiple luminaires in a lighting system if one or more individual luminaires reaches an intensity limit. For example if one luminaire is moved far away from the subject and reaches a maximum intensity, the remaining luminaires may dim to so that their contributions to the scene illumination are of proper proportion.

In some embodiments, each value of the altitude and azimuth of the luminaire 100 with respect to the subject may be assigned to a different associated pixel, and the controller may control the light source(s) of the luminaire 100 to provide an output color matching the color of the single pixel assigned to the altitude and azimuth. In addition or alternatively, each value of the altitude and azimuth of the luminaire 100 may be assigned to a different associated group of pixels, and the controller may control the light source(s) of the luminaire 100 to provide an output color gradient matching colors of the pixels in the group of pixels. In addition or alternatively, each value of the altitude and azimuth of the luminaire 100 may be assigned to a different associated group of pixels, and the controller may control the light source(s) of the luminaire 100 to provide an output color representing an average color value of the pixels in the group of pixels.

The controller of the luminaire may be provided in a variety of configurations. FIG. 3, for example, is a block diagram of a lighting system 300 including a luminaire 100 with a controller 302 configured in accordance with an embodiment of the present disclosure. In the embodiment illustrated in FIG. 3, the controller 302 is operatively coupled (e.g., by a communication bus/interconnect) with light source(s) 304 of luminaire 100. The controller 302 may be populated on a circuit board in the housing of the luminaire 100 or in a separate location such as in the ceiling or wall. The controller 302 receives orientation outputs from one or more orientation sensors 306 and calculates the position of the luminaire 100 relative to a subject 102. The controller 302 outputs control signals to any one or more of the light source(s) 304 to cause the light source(s) 304 to provide one or more output beams to illuminate the subject 102 with light having a color that mimics the color associated with lighting scene position corresponding to the position of the luminaire 100.

In the illustrated embodiment, the controller 302 includes a processor 308 operatively coupled to a memory 310 and to the light source(s) 304 through a communication bus/interconnect. One or more modules stored in the memory 310 may be accessed and executed by the processor 308. In the illustrated embodiment, the memory 310 includes and a lighting scene mapping module 312, a command interpretation module 314, and a self-identification module 316. The memory 310 may also store lighting scene data 318, e.g. color information for each pixel in a lighting scene. In the illustrated example embodiment, the orientation sensors 306 and a communication module 320 are coupled to the controller 302 through the communication bus/interconnect.

The processor 308 may access and execute the lighting scene mapping module 312. The lighting scene mapping module 312 may be configured to receive orientation outputs from the orientation sensors 306 and to calculate the position, e.g. altitude and azimuth and distance, of the luminaire 100 relative to a subject 102 from the orientation outputs. Using the coordinate system established for the lighting scene 104, the lighting scene mapping module 312 may map the calculated position of the luminaire 100 to corresponding color information associated with one or more pixel(s) of the lighting scene 104. The lighting scene mapping module 312 may access the corresponding color information in the lighting scene data 318 and provide an output to the light source(s) 304 to cause the light source(s) to emit light having a color or colors corresponding to the color information associated with the position of the luminaire 100.

The lighting scene mapping module 312 may also or alternatively calculate a light intensity from distance information in the orientation outputs, and the drive the light source(s) 304 to emit light having an intensity that depends on the distance information. For example, different distances from the subject 102 may be assigned different intensity levels in a look-up table of the lighting scene data 318. The lighting scene mapping module 312 may establish an intensity level for the light emitted by the light source(s) 304 by accessing the look-up table and providing an intensity output corresponding to the intensity level stored in the look-up table that corresponds to the distance calculated from the orientation outputs.

The lighting system 300 may also include a system controller 322 for controlling the luminaire 100 through a hard-wired or wireless (e.g. radio-based or optical) interface such as a personal computer, smart phone, tablet or other mobile device. The communication module 320 of the luminaire 100 may include a transceiver coupled to the communication bus/interconnect for sending data to/from a transceiver in the system controller 322. In some embodiments, the communication module 320 may communicate with the system controller 322 using a digital communications protocol, such as a digital multiplexer (DMX) interface, a Wi-Fi™ protocol, a digital addressable lighting interface (DALI) protocol, a ZigBee protocol, or any other suitable communications protocol, wired and/or wireless, as will be apparent in light of this disclosure.

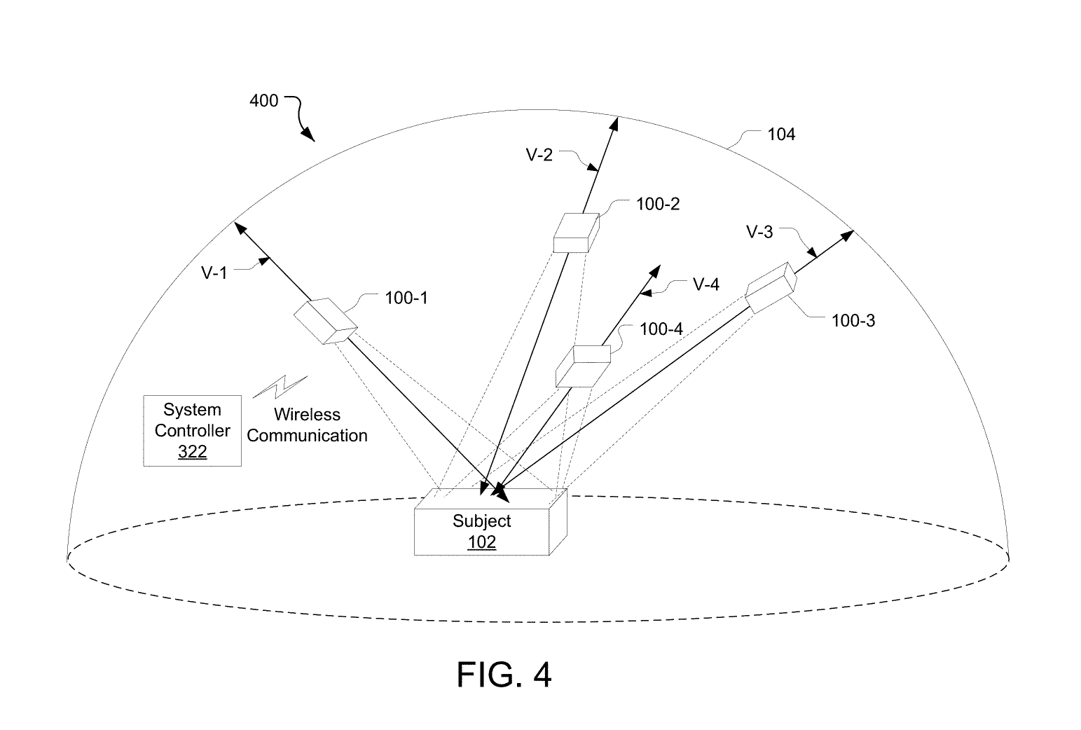

For simplicity of explanation, the system controller 322 in FIG. 3 is shown to only be connected with one luminaire 100, however any number of luminaires 100 may be connected with the system controller 322 and the individual luminaires 100 may also be connected with each other using a hard-wired and/or wireless network. FIG. 4, for example, illustrates a lighting system 400 including a plurality of luminaires 100-1, 100-2, 100-3, 100-4 positioned with a different associated orientation vectors V-1, V-2, V-3, V-4 for illuminating a subject 102. The orientation of each luminaire 100-1, 100-2, 100-3, 100-4 with respect to the subject 102 may be used to determine a corresponding position in a lighting scene 104 relative to the subject 102 and the light source(s) of each luminaire 100 may be controlled to illuminate the subject 102 with light that mimics the color and intensity associated with the corresponding position of the luminaire 100-1, 100-2, 100-3, 100-4 in the lighting scene 104.

In some embodiments the memory 310 of each luminaire 100-1, 100-2, 100-3, 100-4 may store a unique identification number for each luminaire 100-1, 100-2, 100-3, 100-4 in the lighting system, as well as configuration and characterization information regarding the luminaire 100-1, 100-2, 100-3, 100-4. This information may be used to calculate and activate an individual communication channel between the luminaire 100-1, 100-2, 100-3, 100-4 and the system controller 322. The individual communication channel may allow each luminaire 100-1, 100-2, 100-3, 100-4 to be controlled independently by the system controller 322.

With reference again to FIG. 3, the self-identification module 316 allows the controller 302 to communicate identification and configuration information regarding the luminaire 100 to the system controller 322. The self-identification module 316 may initiate or respond to handshake and discovery protocols from the system controller 322, or from any other device within the network. Each luminaire 100 may be assigned a unique network address, and this network address may be stored in the memory 310. In such an example embodiment, the system controller 322 does not need to be pre-programmed with identification and configuration information regarding each of the luminaires 100 in the network because it can receive this information from each luminaire 100 in the system.

The command interpretation module 314 is configured to receive, store, and interpret commands and scene settings that are received from the system controller 322. In one embodiment, for example, lighting scene information may be communicated from the system controller 322 to the luminaire 100. The command interpretation module 314 may be configured to store the lighting scene information in the lighting scene data 318 or provide an output to the light source(s) 304 to cause the light source(s) 304 to emit light having a color or colors corresponding to the color information in a lighting scene 104 stored in memory of the system controller 322 or stored in remote memory 324, e.g. a cloud-based memory.

In an embodiment in which lighting scene data is stored in the system controller 322 or in a remote memory 324, for example, orientation outputs from the orientation sensors 306 may be communicated to the system controller 322, and, using a coordinate system established for the lighting scene 104, a lighting scene mapping and interface module 326 in the system controller 322 may map the calculated position of the luminaire 100 to corresponding color information associated with one or more pixel(s) of the lighting scene 104. The lighting scene mapping and interface module 326 may access the corresponding color information in the lighting scene data in memory at the system controller 322 or in the remote memory 324 and provide control signals to the luminaire 100. The command interpretation module 314 may receive the control signals from the system controller 322 and provide an output to the light source(s) 304 to cause the light source(s) 304 to emit light having a color or colors corresponding to the color information associated with the position of the luminaire 100 in the lighting scene. In embodiments in which lighting scene data is stored in the system controller 322 or in remote memory 324, the lighting scene mapping module 312 and lighting scene data 318 in the memory 310 of the controller 302 may not be necessary.

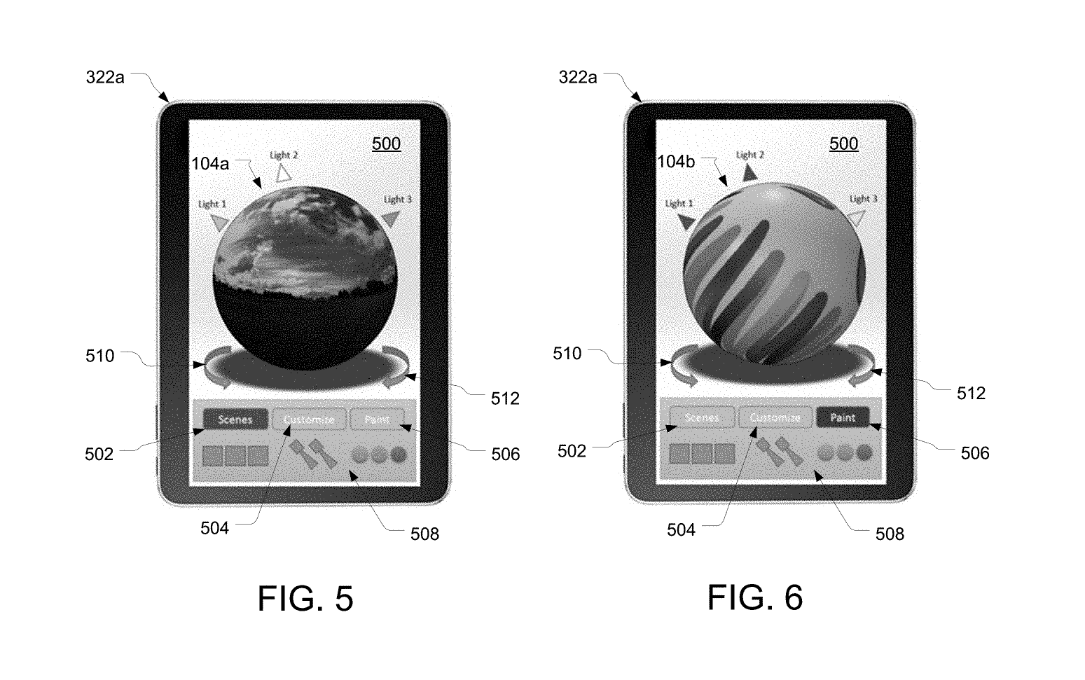

With reference to FIGS. 5 and 6, in some embodiments the system controller may be configured as a mobile device 322a, e.g. a smart phone or tablet, and may include display 500, e.g. a touch sensitive interface. A lighting scene and mapping module 326 in the system controller 322a may be configured to provide a user interface on the display 500 to allow the user to select, modify or create lighting scenes 104 used in a lighting system consistent with the present disclosure. FIGS. 5 and 6, for example, illustrate lighting scenes 104a, 104b, e.g. mapped onto a sphere or projected flat, displayed on the display 500, along with user interface buttons and the relative orientation and light output color of the luminaires 100 in the network. In the illustrated embodiment, the user interface buttons include a scenes button 502 to allow a user to select a desired lighting scene, e.g. from a locally or remotely stored database of lighting scenes, a customize button 504 to allow a user to create a custom lighting scene and/or modify the color and intensity of selected luminaires, and a paint button 506 for allowing a user to create or modify a lighting scene by painting directly on the displayed lighting scene image using a color palette and painting tools 508. FIG. 5 for example, illustrates a selected lighting scene 104a selected by a user using the scenes button 502, and FIG. 6 illustrates a painted lighting scene 104a painted by a user using the paint button 506.

The user interface 500 may also include rotation buttons 510, 512 to allow use to swipe the display to rotate and fix the heading or orientation of a displayed lighting scene with respect to the luminaires in the system. In the illustrated embodiment, for example, the display 500 shows a relative position of each luminaire in the network to the lighting scene 104a, 104b using associated triangle (Light 1, Light 2, Light 3) filled with a color indicating a light output color of the luminaire. The user may rotate the lighting scene 104a, 104b using the rotation buttons 510, 512 until a desired light output color is achieved for the luminaires as indicated by the color of the triangles (Light 1, Light 2, Light 3). The luminaires with the network may respond in real-time to selections or modifications made to a lighting scene by a user using the user interface by providing a light output, as described above, which mimics the color and intensity of the lighting scene in the direction corresponding to the position of the luminaire.

There is thus provided a luminaire that produces a light output spectrum based on its physical location relative to a subject within a lighting scene. The output color(s) and intensity of the luminaire may adjust in real-time as it is moved in response to the position of the luminaire with respect to a subject. In some embodiments, the light output of the luminaire mimics light associated with a lighting scene. The lighting scene may be selected, customized/modified or created by a user to achieve different lighting environments and the luminaire may adjust its light output dynamically in response to change in the lighting scene. This may be especially useful in contextual lighting environments such as retail environments where a customer wishes to see a potential purchase, e.g. clothing, furniture, etc., in different lighting environments and lighting environments such as theatre, film and photography where lights are frequently moved to achieve desired lighting for a subject. Even in situations where luminaires are infrequently moved, the ability of the luminaires to dynamically change as they are installed may be useful with commissioning a lighting system.

Numerous implementations are apparent in light of this disclosure. One example implementation provides a luminaire including a light source, at least one orientation sensor configured to provide at least one orientation output representative of the position of the luminaire relative to a subject, and a controller communicatively coupled to the light source and configured to provide one or more control signals for controlling the light source to provide a light output for illuminating the subject in response to the orientation output of the at least one orientation sensor.

In some embodiments, the controller is configured to control the light source to establish a color or intensity of the light output in response to the orientation output of the at least one orientation sensor. In some embodiments, the at least one orientation output includes an altitude output representative of an altitude of the luminaire relative to the subject and an azimuth output representative of an azimuth of the luminaire relative to the subject, and a color or intensity of the light output is determined in response to the altitude output and the azimuth output. In some embodiments, the at least one orientation output includes a distance output, and a color or intensity of the light output is determined in response to the distance output. In some embodiments, the light output is determined from a lighting scene. In some embodiments, the lighting scene includes a plurality of coordinates, and each of the plurality of coordinates has an associated light output, and the controller is further configured to establish a correspondence between the at least one orientation output and one of the plurality of coordinates to determine the light output of the light source. In some embodiments, the luminaire further includes a memory for storing data representative of the lighting scene. In some embodiments, the controller is configured to communicate with a system controller to receive data representative of the lighting scene. In some embodiments, the controller is further configured to communicate the at least one orientation output to a system controller, receive one or more signals from the system controller, and provide the one or more control signals in response to the one or more signals from the system controller.

Another example implementation provides a lighting system including at least one luminaire that includes a light source, at least one orientation sensor configured to provide at least one orientation output representative of the position of the luminaire relative to a subject, and a controller communicatively coupled to the light source and configured to provide one or more control signals for controlling the light source to provide a light output for illuminating the subject in response to the orientation output of the at least one orientation sensor, and a system controller communicatively coupled to the controller.

In some embodiments, the controller is configured to control the light source to establish a color or intensity of the light output in response to the orientation output of the at least one orientation sensor. In some embodiments, the at least one orientation output includes an altitude output representative of an altitude of the luminaire relative to the subject and an azimuth output representative of an azimuth of the luminaire relative to the subject, and a color or intensity of the light output is determined from a lighting scene in response to the altitude output and the azimuth output. In some embodiments, the at least one orientation output includes a distance output, and a color or intensity of the light output is determined in response to the distance output. In some embodiments, the light output is determined from a lighting scene. In some embodiments, the lighting scene includes a plurality of coordinates, and each of the plurality of coordinates has an associated light output, and the system controller is further configured to establish a correspondence between the at least one orientation output and one of the plurality of coordinates to determine the light output of the light source. In some embodiments, the system controller includes a user interface configured for selecting, modifying, or creating the lighting scene. In some embodiments, the controller is further configured to communicate the at least one orientation output to the system controller, receive one or more signals from the system controller, and provide the one or more control signals in response to the one or more signals from the system controller.

Another example embodiment provides a lighting system including: a method of illuminating a subject with light output from at least one luminaire, the method including receiving an orientation output from an orientation sensor of the luminaire, and controlling a light source of the luminaire to illuminate a subject with a light output in response to the orientation output.

In some embodiments, the method further includes obtaining a lighting scene, in which the lighting scene includes a plurality of coordinates, and each of the plurality of coordinates has an associated light output, and establishing a correspondence between the orientation output and one of the plurality of coordinates to determine the light output of the light source. In some embodiments, the method further includes selecting, modifying, or creating the lighting scene using a user interface of a system controller communicatively coupled to the luminaire.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

Embodiments of the methods described herein may be implemented using a controller, processor and/or other programmable device. To that end, the methods described herein may be implemented on a tangible, non-transitory computer readable medium having instructions stored thereon that when executed by one or more processors perform the methods. Thus, for example, controller 302 and or system controller 322 may include a storage medium to store instructions (in, for example, firmware or software) to perform the operations described herein. The storage medium may include any type of tangible medium, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

It will be appreciated by those skilled in the art that any block diagrams herein represent conceptual views of illustrative circuitry embodying the principles of the disclosure. Similarly, it will be appreciated that any block diagrams, flow charts, flow diagrams, state transition diagrams, pseudocode, and the like represent various processes which may be substantially represented in computer readable medium and so executed by a computer or processor, whether or not such computer or processor is explicitly shown. Software modules, or simply modules which are implied to be software, may be represented herein as any combination of flowchart elements or other elements indicating performance of process steps and/or textual description. Such modules may be executed by hardware that is expressly or implicitly shown.

The functions of the various elements shown in the figures, including any functional blocks labeled as “controller”, may be provided through the use of dedicated hardware as well as hardware capable of executing software in association with appropriate software. The functions may be provided by a single dedicated processor, by a single shared processor, or by a plurality of individual processors, some of which may be shared. Moreover, explicit use of the term “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

As used in any embodiment herein, a “circuit” or “circuitry” may include, for example, singly or in any combination, hardwired circuitry, programmable circuitry, state machine circuitry, and/or firmware that stores instructions executed by programmable circuitry.

The term “coupled” as used herein refers to any connection, coupling, link or the like by which signals carried by one system element are imparted to the “coupled” element. Such “coupled” devices, or signals and devices, are not necessarily directly connected to one another and may be separated by intermediate components or devices that may manipulate or modify such signals. Likewise, the terms “connected” or “coupled” as used herein in regard to mechanical or physical connections or couplings is a relative term and does not require a direct physical connection.

Elements, components, modules, and/or parts thereof that are described and/or otherwise portrayed through the figures to communicate with, be associated with, and/or be based on, something else, may be understood to so communicate, be associated with, and/or be based on in a direct and/or indirect manner, unless otherwise stipulated herein.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

1. A luminaire comprising:
a light source;
at least one orientation sensor configured to provide at least one orientation output representative of the position of the luminaire relative to a subject; and
a controller communicatively coupled to the light source and configured to:
calculate the position of the luminaire relative to a subject based only on the orientation output from the at least one orientation sensor of the luminaire;
provide one or more control signals for controlling the light source to provide a light output for illuminating the subject based on the calculated position.

2. The luminaire of claim 1, wherein the controller is configured to control the light source to establish a color or intensity of the light output in response to the orientation output of the at least one orientation sensor.

3. The luminaire of claim 1, wherein the at least one orientation output comprises an altitude output representative of an altitude of the luminaire relative to the subject and an azimuth output representative of an azimuth of the luminaire relative to the subject, and wherein a color or intensity of the light output is determined in response to the altitude output and the azimuth output.

4. The luminaire of claim 1, wherein the at least one orientation output comprises a distance output, and wherein a color or intensity of the light output is determined in response to the distance output.

5. The luminaire of claim 1, wherein the light output is determined from a lighting scene.

6. The luminaire of claim 5, wherein:
the lighting scene comprises a plurality of coordinates, and each of the plurality of coordinates has an associated light output; and
the controller is further configured to establish a correspondence between the at least one orientation output and one of the plurality of coordinates to determine the light output of the light source.

7. The luminaire of claim 5, further comprising a memory for storing data representative of the lighting scene.

8. The luminaire of claim 5, wherein the controller is configured to communicate with a system controller to receive data representative of the lighting scene.

9. The luminaire of claim 1, wherein the controller is further configured to:
communicate the at least one orientation output to a system controller;
receive one or more signals from the system controller; and
provide the one or more control signals in response to the one or more signals from the system controller.

10. A lighting system comprising:
at least one luminaire comprising:
a light source;
at least one orientation sensor configured to provide at least one orientation output representative of the position of the luminaire relative to a subject; and
a controller communicatively coupled to the light source and configured to:
calculate the position of the luminaire relative to a subject based only on the orientation output from the at least one orientation sensor of the luminaire;
provide one or more control signals for controlling the light source to provide a light output for illuminating the subject based on the calculated position; and
a system controller communicatively coupled to the controller.

11. The lighting system of claim 10, wherein the controller is configured to control the light source to establish a color or intensity of the light output in response to the orientation output of the at least one orientation sensor.

12. The lighting system of claim 10, wherein the at least one orientation output comprises an altitude output representative of an altitude of the luminaire relative to the subject and an azimuth output representative of an azimuth of the luminaire relative to the subject, and wherein a color or intensity of the light output is determined from a lighting scene in response to the altitude output and the azimuth output.

13. The lighting system of claim 10, wherein the at least one orientation output comprises a distance output, and wherein a color or intensity of the light output is determined in response to the distance output.

14. The lighting system of claim 10, wherein the light output is determined from a lighting scene.

15. The lighting system of claim 14, wherein:
the lighting scene comprises a plurality of coordinates, and each of the plurality of coordinates has an associated light output; and
the system controller is further configured to establish a correspondence between the at least one orientation output and one of the plurality of coordinates to determine the light output of the light source.

16. The lighting system of claim 14, wherein the system controller comprises a user interface configured for selecting, modifying, or creating the lighting scene.

17. The lighting system of claim 10, wherein the controller is further configured to:
communicate the at least one orientation output to the system controller;
receive one or more signals from the system controller; and
provide the one or more control signals in response to the one or more signals from the system controller.

18. A method of illuminating a subject with light output from at least one luminaire, the method comprising:
receiving, by the luminaire, an orientation output from an orientation sensor of the luminaire;
calculating, by the luminaire, a position of the luminaire relative to the subject based only on the orientation output from the orientation sensor of the luminaire; and
controlling, by the luminaire, a light source of the luminaire to illuminate a subject with a light output based on the calculated position.

19. The method of claim 18, further comprising:
obtaining a lighting scene, wherein the lighting scene comprises a plurality of coordinates, and each of the plurality of coordinates has an associated light output; and
establishing a correspondence between the orientation output and one of the plurality of coordinates to determine the light output of the light source.

20. The method according to claim 19, further comprising:
selecting, modifying, or creating the lighting scene using a user interface of a system controller communicatively coupled to the luminaire.
